(19) United States
(12) Patent Application Publication
(10) Pub. No.: US 2023/0311386 A1
(43) Pub. Date: Oct. 5, 2023

(54) MOLD DEVICE

(71) Applicant: HONDA MOTOR CO., LTD., Tokyo (JP)

(72) Inventors: Hiroshi Mohri, Tokyo (JP); Masaki Tokudome, Tokyo (JP); Hiroshi Matsushima, Tokyo (JP); Hiroaki Iwanishi, Tokyo (JP); Takuya Kawashima, Tokyo (JP); Shinichi Nobuhara, Tokyo (JP)

(21) Appl. No.: 18/127,693

(22) Filed: Mar. 29, 2023

(30) Foreign Application Priority Data
Mar. 30, 2022 (CN) 202210333788.2

(51) Int. Cl. B29C 45/33; B29C 45/16; B29C 45/26; B29L 31/30

(52) U.S. Cl. CPC B29C 45/332; B29C 45/1671; B29C 45/2606; B29L 2031/3044

(57) ABSTRACT

In a mold device, a side portion of a second mold forming a second cavity portion is deformed outward in a second direction by injection pressure during injection molding, and an insert is displaced along with the deformation of the side portion. A drive portion moves the insert in a drive direction intersecting the first direction and the second direction so as to be able to advance and retract between a molding position at which the molded article can be molded and a retracted position at which the molded article can be released. The insert is swingably attached to the drive portion.

### CROSS-REFERENCE TO RELATED APPLICATIONS

This application is based upon and claims the benefit of priority from Chinese Patent Application No. 202210333788.2 filed on Mar. 30, 2022, the contents of which are incorporated herein by reference.

### BACKGROUND OF THE INVENTION

### Field of the Invention

The present invention relates to a mold device.

### Description of the Related Art

The mold device comprises, for example, a fixed mold, a movable mold, and an insert. The fixed mold, the movable mold and the insert form a cavity for injection molding of a molded article. The cavity includes a first cavity portion, a second cavity portion, and a third cavity portion. The first cavity portion extends in the second direction perpendicular to the first direction, which is the mold clamping direction of the movable mold. The second cavity portion extends from the first cavity portion in a direction intersecting the second direction. The third cavity portion is positioned at an end portion of the second cavity portion and forms an undercut portion of the molded article.

The fixed mold molds the outer surface of the molded article. The movable mold molds the inner surface of the molded article. The insert forms an undercut portion. In such a mold device, because the mold clamping force does not act in the second direction, the side portion of the fixed mold for molding the outer surface of the second cavity portion is deformed outwardly in the second direction by the injection pressure during injection molding. Then, the molding surface of the side portion (surface for molding the cavity) is shifted with respect to the molding surface of the insert (surface for molding the cavity), resulting in that burrs may form on the molded article.

For example, in the case of the mold device disclosed in JP 2020-082598 A, at the time of injection molding, the side portion of the fixed mold is deformed outward in the second direction by the injection pressure and pushes an insert outward in the second direction, thereby sliding the insert. As a result, a positional deviation between the molding surface of the side portion and the molding surface of the insert is suppressed, and generation of burrs on the molded article is suppressed. The mold device has a drive portion for advancing and retracting the insert along the second direction.

### SUMMARY OF THE INVENTION

In the mold device, a drive portion may be arranged so that the insert advances and retracts in a direction intersecting the first direction and the second direction. Then, because the direction in which the side portion is deformed during injection molding and the direction in which the insert is advanced and retracted by the drive portion are different from each other, the movement of the insert in the second direction is obstructed by the drive portion. In this case, the insert cannot be displaced outward in the second direction along with the deformation of the side portion at the time of injection molding.

An object of the present invention is to solve the above-described problems.

One aspect of the present invention is a mold device wherein a cavity for injection molding of a molded article is formed by a first mold, a second mold, and an insert, the cavity includes a first cavity portion that extends in a second direction perpendicular to a first direction that is a mold clamping direction of the first mold and the second mold, a second cavity portion that extends from the first cavity portion in a direction intersecting the second direction, and a third cavity portion that is positioned at an extended end portion of the second cavity portion and is configured to mold an undercut portion of the molded article, the first mold molds an inner surface of the molded article, the second mold molds an outer surface of the molded article, the insert molds the undercut portion, and during the injection molding, a side portion of the second mold forming the second cavity portion deforms outward in the second direction by injection pressure, and the insert is displaced along with the deformation of the side portion, the mold device comprising a drive portion that is configured to move the insert in a drive direction intersecting the second direction in a manner so that the insert advances and retracts between a molding position at which the molded article is molded and a retracted position at which the molded article is released, wherein the insert is swingably attached to the drive portion.

According to the present invention, the insert is swingably attached to the drive portion. Thus, even if the direction in which the side portion deforms during injection molding and the direction in which the insert advances and retracts are different from each other, the insert can be displaced outward in the second direction along with the deformation of the side portion. Therefore, it is possible to suppress the generation of burrs on molded articles.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a partially omitted longitudinal sectional view of a mold device according to an embodiment of the present invention.

FIG. 2 is a partially enlarged sectional view of FIG. 1.

FIG. 3 is a partially omitted cross-sectional view taken along a line III-III of FIG. 2.

FIG. 4 is a first explanatory view showing a procedure of assembling an insert into a first mold.

FIG. 5 is a second explanatory view showing the procedure of assembling the insert into the first mold.

FIG. 6 is a partially omitted longitudinal sectional view of the mold device showing a state in which the insert is tilted.

### DETAILED DESCRIPTION OF THE INVENTION

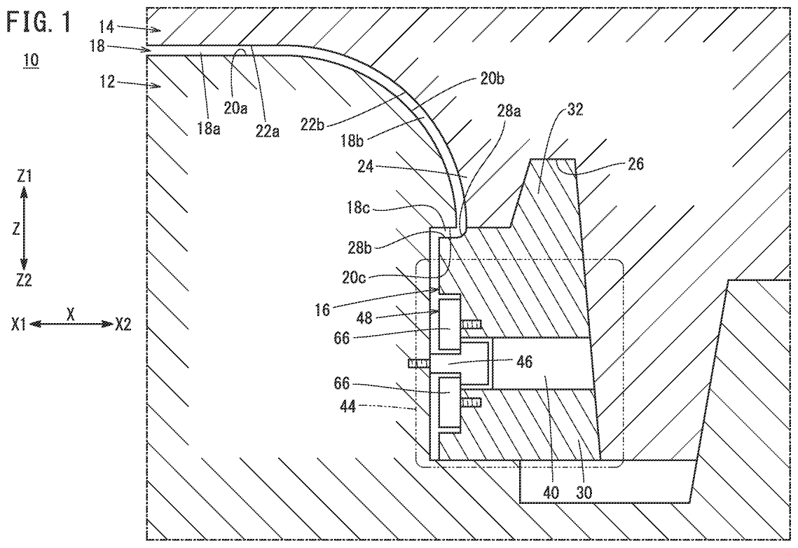

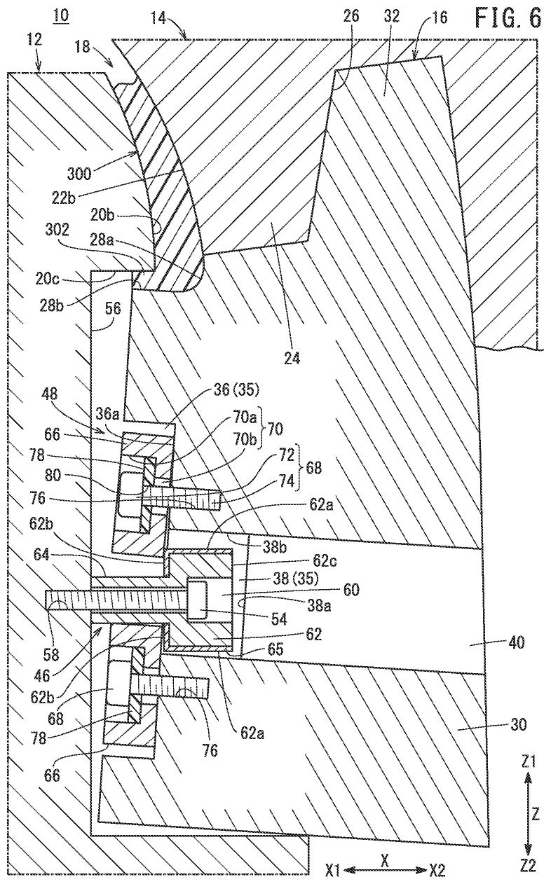

As shown in FIG. 1, a mold device 10 according to an embodiment of the present invention performs injection molding of a molded article 300 (see FIG. 6) such as a bumper of a vehicle. The molded article 300 is not limited to a bumper of a vehicle.

The mold device 10 is provided with a first mold 12, a second mold 14, and an insert 16. The first mold 12, the second mold 14, and the insert 16 form a cavity 18 for injection molding of the molded article 300. The cavity 18 includes a first cavity portion 18a, a second cavity portion 18b, and a third cavity portion 18c.

The first cavity portion 18a extends in a second direction (direction of arrow X) orthogonal to a first direction (direction of arrow Z), which is the mold clamping direction of the first mold 12 and the second mold 14. The second cavity portion 18b extends from an end portion of the first cavity portion 18a in a direction intersecting the first direction and the second direction. The third cavity portion 18c extends inward in the second direction (direction of arrow X1) from an extended end portion of the second cavity portion 18b. The third cavity portion 18c is a space for molding an undercut portion 302 (see FIG. 6) of the molded article 300.

The first mold 12 and the second mold 14 are arranged so as to face each other in the first direction. The first mold 12 is a movable mold, and the second mold 14 is a fixed mold. However, in the mold device 10, the first mold 12 may be a fixed mold and the second mold 14 may be a movable mold. The second mold 14 is positioned in the direction of arrow Z1 seen from the first mold 12.

The first mold 12 is movable relative to the second mold 14 in the mold clamping direction (direction of arrow Z1) and the mold opening direction (direction of arrow Z2). The first mold 12 molds the inner surface of the molded article 300. The first mold 12 has a first inner molding surface 20a, a second inner molding surface 20b, and a third inner molding surface 20c.

The second mold 14 molds the outer surface of the molded article 300. The second mold 14 has a first outer molding surface 22a and a second outer molding surface 22b. The first outer molding surface 22a and the first inner molding surface 20a face each other and form a first cavity portion 18a in the mold clamping state of the first mold 12 and the second mold 14 (hereinafter simply referred to as “mold clamping state”). The second outer molding surface 22b and the second inner molding surface 20b face each other and form a second cavity portion 18b in the mold clamping state.

The second mold 14 includes a side portion 24 forming the second cavity portion 18b. The side portion 24 has the second outer molding surface 22b. The side portion 24 is formed with a fitting recess 26, being dented in the direction of the arrow Z1. The fitting recess 26 is formed to have narrower widths in the direction of the arrow Z1. In other words, the width of the fitting recess 26 in the direction of arrow X becomes narrower in the direction of the arrow Z1.

The insert 16 has a first molding surface 28a and a second molding surface 28b. In the mold clamping state, the first molding surface 28a is arranged so as to be continuous with the second outer molding surface 22b without any step. The first molding surface 28a, together with the second outer molding surface 22b, molds the outer surface (design surface) of the molded article 300. The first molding surface 28a forms a boundary between the second cavity portion 18b and the third cavity portion 18c. The second molding surface 28b extends inward in the second direction (in the direction of arrow X1) from the first molding surface 28a. The second molding surface 28b and the third inner molding surface 20c form a third cavity portion 18c.

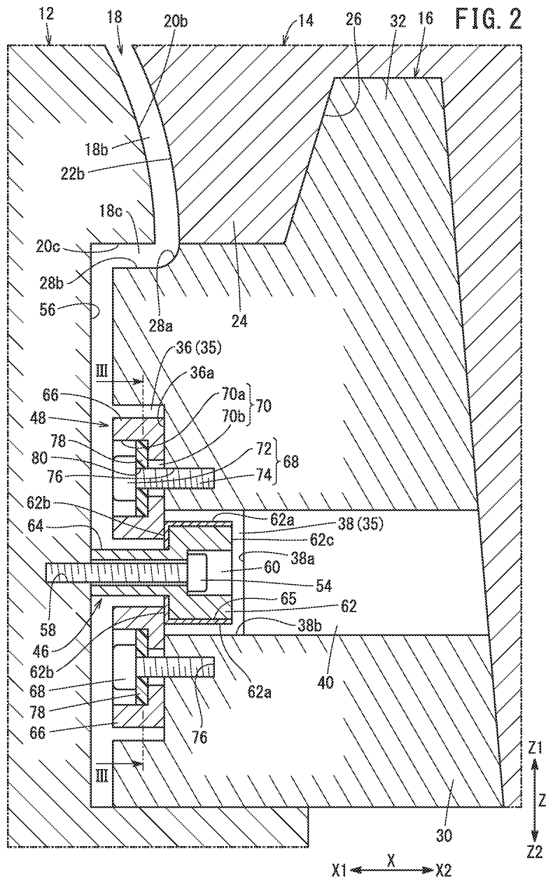

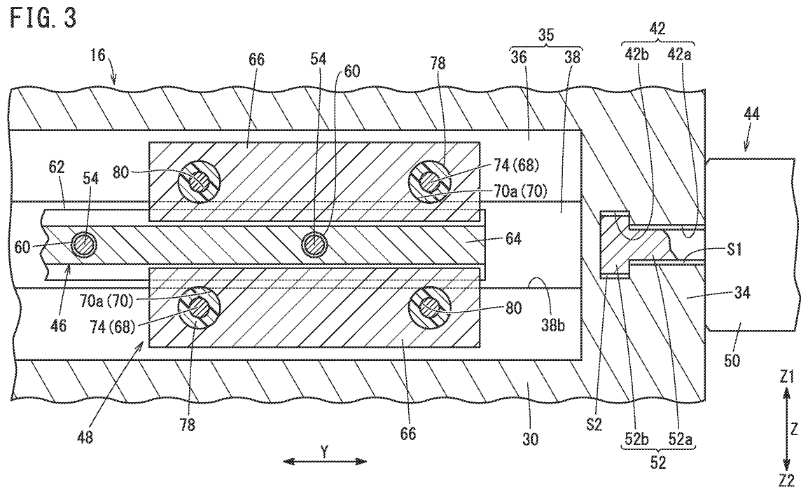

As shown in FIGS. 2 and 3, the insert 16 has an insert body 30, a fitting projection 32, and a connecting portion 34. The insert body 30 extends along a third direction (driving direction, arrow Y direction) orthogonal to the first direction and the second direction.

A recess 35 is formed on a surface of the insert body 30 facing inward in the second direction (a surface facing the first mold 12). The recess 35 includes a first groove 36 and a second groove 38. The first groove 36 extends in the direction of arrow Y. The first groove 36 is positioned at an intermediate portion of the insert 16 in the direction of arrow Z. The cross-sectional shape of the first groove 36 is, for example, a quadrangular shape (see FIG. 2).

The second groove 38 is formed on the groove bottom surface 36a of the first groove 36. The second groove 38 extends over the entire length of the first groove 36. The cross-sectional shape of the second groove 38 is, for example, a quadrangular shape. The groove width (length in the direction of arrow Z) of the second groove 38 is smaller than the groove width (length in the direction of arrow Z) of the first groove 36.

In FIG. 2, a through hole 40 extending linearly in the direction of arrow X is formed on a groove bottom surface 38a of the second groove 38. The through hole 40 is open on a surface of the insert body 30 facing outward in the second direction (direction of arrow X2). The through hole 40 is a hole for attaching a guide member 46 (described later) to the first mold 12.

The fitting projection 32 protrudes in the direction of arrow Z1 from the surface of the insert body 30 facing the direction of arrow Z1. The fitting projection 32 is fitted into the fitting recess 26 of the second mold 14 in the mold clamping state. The fitting projection 32 is formed to have narrower widths in the direction of arrow Z1.

In FIG. 3, the connecting portion 34 is positioned at an end portion of the insert body 30 in the third direction (direction of arrow Y). The connection portion 34 is formed with a connection hole 42. The connection hole 42 includes a first connection hole 42a and a second connection hole 42b. The first connection hole 42a is a circular hole extending in the direction of arrow Y. The first connection hole 42a opens on a surface of the connection portion 34 in a direction away from the insert body 30. The second connection hole 42b is a circular hole communicating with an end portion of the first connection hole 42a close to the insert body 30. The inner diameter of the second connection hole 42b is larger than the inner diameter of the first connection hole 42a.

As shown in FIGS. 2 and 3, the mold device 10 further includes a drive portion 44, a guide member 46, and a support member 48. In FIG. 3, the drive portion 44 moves the insert 16 in the third direction (a direction intersecting the first direction and the second direction) so that the insert 16 can advance and retract between a molding position where the molded article 300 can be molded and a retracted position where the molded article 300 can be released.

The drive portion 44 is, for example, an air cylinder device. However, the drive portion 44 may be an electric cylinder device. The drive portion 44 includes a cylinder portion 50 and a rod portion 52. The cylinder portion 50 is fixed to the first mold 12 by an attachment member (not shown). The cylinder portion 50 has a cylinder hole (not shown) through which a piston (not shown) slides in the direction of arrow Y.

The rod portion 52 is inserted into the connection hole 42. Specifically, the rod portion 52 has a first rod portion 52a and a second rod portion 52b. The first rod portion 52a is inserted into the first connection hole 42a. The first rod portion 52a extends in the direction of arrow Y. The first rod portion 52a is formed in a cylindrical shape, for example.

An end portion of the first rod portion 52a in the direction away from the insert body 30 is connected to a piston (not shown) of the cylinder portion 50. The outer diameter of the first rod portion 52a is smaller than the inner diameter of the first connection hole 42a. In other words, a first gap S1 is formed between the outer peripheral surface of the first rod portion 52a and the inner peripheral surface of the first connection hole 42a.

The second rod portion 52b is inserted into the second connection hole 42b. The second rod portion 52b is formed in a cylindrical shape, for example. The second rod portion 52b has a larger diameter than the first rod portion 52a. That is, the second rod portion 52b protrudes radially further outward than the first rod portion 52a.

The outer diameter of the second rod portion 52b is larger than the inner diameter of the first connection hole 42a and smaller than the inner diameter of the second connection hole 42b. In other words, a second gap S2 is formed between the outer peripheral surface of the second rod portion 52b and the inner peripheral surface of the second connection hole 42b. The first gap S1 and the second gap S2 are set to such a size that the insert 16 can be tilted (rotated) relative to the drive portion 44 in the circumferential direction of the rod portion 52.

As shown in FIGS. 2 and 3, the guide member 46 guides the insert 16 along the third direction (direction of arrow Y). The guide member 46 is fixed to the first mold 12. The guide member 46 extends in the direction of arrow Y. In FIG. 2, the guide member 46 has a T-shaped cross-sectional shape. The guide member 46 is made of metal material, for example.

The guide member 46 is attached to a mounting surface 56 of the first mold 12 by a plurality of fastening members 54. The mounting surface 56 is oriented in the direction of arrow X2. The plurality of fastening members 54 are bolts, for example. The mounting surface 56 is formed with a fastening hole 58 into which the fastening member 54 is screwed. The guide member 46 is formed with a plurality of insertion holes 60 through which the plurality of fastening members 54 are inserted. The guide member 46 has an engaging portion 62 and an extending portion 64.

The engaging portion 62 is disposed in the second groove 38. The cross-sectional shape of the engaging portion 62 is, for example, a rectangular shape extending in the direction of arrow Z. The extending portion 64 extends from the engaging portion 62 toward the mounting surface 56. The cross-sectional shape of the extending portion 64 is, for example, a rectangular shape extending in the direction of arrow X. An end portion of the extending portion 64 in the direction of arrow X1 is in contact with the mounting surface 56. The engaging portion 62 protrudes more in the direction of arrow Z1 and the direction of arrow Z2 than the extending portion 64.

A pair of outer side surfaces 62a of the engaging portion 62 in the direction of arrow Z face a pair of groove side surfaces 38b of the second groove 38. A pair of first outer surfaces 62b of the engaging portion 62 in the direction of arrow X1 face the support member 48. A second outer surface 62c of the engaging portion 62 in the direction of arrow X2 faces the groove bottom surface 38a of the second groove 38. A predetermined gap is formed between the second outer surface 62c and the groove bottom surface 38a.

For example, a reinforcing member 65 is embedded in the outer side surface 62a and the first outer surface 62b. The reinforcing member 65 is made of graphite, for example. Thus, the guide member 46 does not easily wear. However, the outer side surface 62a and the first outer surface 62b may be coated with reinforcing material that is harder than the material constituting the guide member 46. In FIGS. 1 to 4, the gap between the outer side surface 62a and the groove side surface 38b and the gap between the second outer surface 62c and the groove bottom surface 38a are exaggerated for convenience.

The support member 48 supports the insert 16 on the guide member 46 so that the insert 16 can be tilted in the circumferential direction of the rod portion 52 around the rod portion 52. The support member 48 includes a pair of support bodies 66. The pair of support bodies 66 are arranged in the first groove 36 in a state of being spaced apart from each other in the direction of arrow Z. The extending portion 64 of the guide member 46 is inserted into the gap between the pair of support bodies 66.

The gap between the pair of support bodies 66 is narrower than the length of the guide member 46 in the direction of arrow Z. The support body 66 is made of, for example, metal material in a plate shape. The support body 66 covers, from the direction of arrow X1, the first outer surface 62b of the engaging portion 62 arranged in the second groove 38. The pair of support bodies 66 prevent the engaging portion 62 from coming out of the second groove 38.

The support body 66 is formed with a plurality (for example, two) of stepped holes 70 through which a plurality of fixing members 68 for attaching the support body 66 to the insert body 30 are inserted. The fixing member 68 is a bolt and has a head 72 and a shaft 74. The outer diameter of the head 72 is larger than the outer diameter of the shaft 74. The shaft 74 is screwed into a fixing hole 76 formed in the groove bottom surface 36a of the first groove 36.

The plurality of stepped holes 70 are located apart from each other in the direction of arrow Y (see FIG. 3). The stepped hole 70 includes a large-diameter hole 70a and a small-diameter hole 70b. The large-diameter hole 70a opens on the outer surface of the support member 48 in the direction of arrow X1. The small-diameter hole 70b opens on the outer surface of the support body 66 in the direction of arrow X2. The large-diameter hole 70a communicates with the small-diameter hole 70b. The large-diameter hole 70a and the small-diameter hole 70b are coaxially arranged. The head 72 of the fixing member 68 is disposed in the large-diameter hole 70a. The shaft 74 of the fixing member 68 is inserted through the small-diameter hole 70b.

An annular elastic member 78 is attached to the large-diameter hole 70a. The elastic member 78 is preferably made of soft resin material such as urethane. The elastic member 78 has a hole 80 through which the shaft 74 of the fixing member 68 is inserted. The support body 66 is attached to the insert body 30 by the fixing member 68 through the elastic member 78.

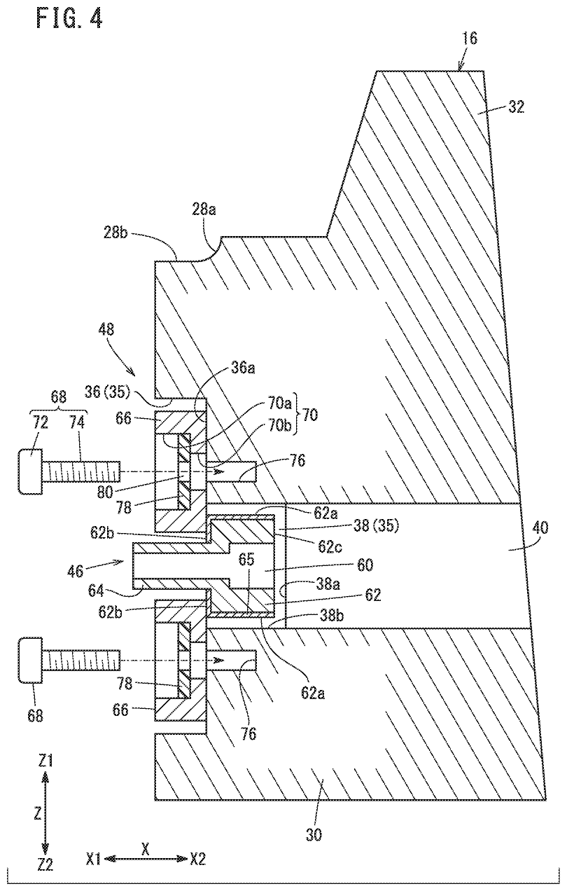

Next, attachment of the insert 16 to the first mold 12 will be described. As shown in FIG. 4, first, the guide member 46 and the support member 48 are assembled to the insert 16. That is, in a state in which the engaging portion 62 of the guide member 46 is arranged in the second groove 38 of the insert body 30 and in addition the pair of support bodies 66 are arranged in the first groove 36, the support body 66 is fixed to the insert body 30 by the plurality of fixing members 68 via the elastic member 78. Thus, the insert 16, the support member 48, and the guide member 46 are integrated.

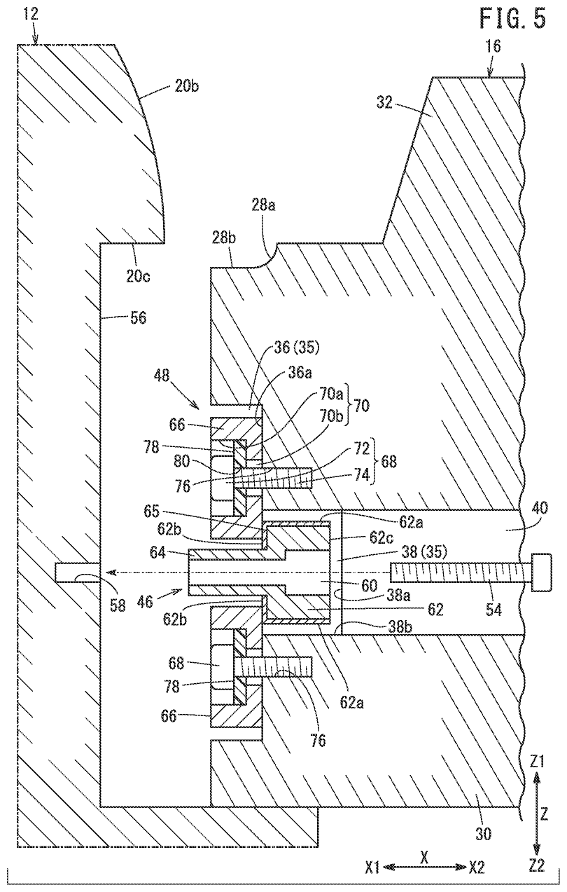

Subsequently, as shown in FIG. 5, the guide member 46 is fixed to the mounting surface 56 of the first mold 12. Specifically, in a state in which the position of the insertion hole 60 of the guide member 46 is aligned with the fastening hole 58 of the mounting surface 56, the fastening member 54 is inserted from the through hole 40 of the insert body 30 through the insertion hole 60 of the guide member 46 and fastened into the fastening hole 58. Thus, the insert 16 can be easily attached to the first mold 12.

Next, a description will be given of a procedure for injection molding of the molded article 300 using the mold device 10. In the initial state, the insert 16 is at the molding position. First, the first mold 12 is moved in the first direction (direction of arrow Z1), which is the mold clamping direction. Then, the fitting projection 32 of the insert 16 is inserted into the fitting recess 26 of the second mold 14.

When the clamping of the first mold 12 is completed, the cavity 18 is formed between the first mold 12, the second mold 14 and the insert 16 (see FIG. 1). Thereafter, molten resin is injected into the cavity 18 from a sprue (not shown) of the second mold 14. Thus, the cavity 18 is filled with the molten resin.

At this time, the side portion 24 of the second mold 14 is subjected to an injection pressure along the outward direction (direction of arrow X2) in the second direction by the molten resin filled in the second cavity portion 18b. Therefore, as shown in FIG. 6, the side portions 24 deforms to be pushed and expanded in the direction of arrow X2. In other words, the position of the second outer molding surface 22b of the side portion 24 is shifted in the direction of arrow X2. When the side portion 24 deforms in the direction of the arrow X2, the fitting projection 32 is pushed in the direction of arrow X2 by the side portion 24, so that force causing the insert 16 to rotate around the rod portion 52 acts on the insert 16. Therefore, the insert 16 is inclined in the direction of arrow X2 with respect to the guide member 46 and the drive portion 44.

Although the tilt angle of the insert 16 is exaggerated in FIG. 6, actually the tilt angle is considerably small. Specifically, the connecting portion 34 of the insert 16 rotates in the circumferential direction of the rod portion 52 with respect to the rod portion 52 of the drive portion 44. At this time, the elastic member 78 is pressed by the head 72 of the fixing member 68 and is compressed and deformed. Thus, the insert 16 can be smoothly tilted with respect to the guide member 46.

When the insert 16 tilts, the first molding surface 28a is displaced in the direction of arrow X2, so that formation of a step between the second outer molding surface 22b and the second molding surface 28b can be suppressed. That is, it is possible to prevent a step from being formed on the outer surface (design surface) of the molded article 300. Therefore, the generation of burrs caused by the deformation of the side portions 24 can be suppressed.

After the molten resin filled in the cavity 18 has solidified, the first mold 12 is moved in the direction of arrow Z2, which is the mold opening direction. Thereafter, the insert 16 is retracted in the direction of arrow Y from the molding position to the retracted position. Thus, the molded article 300 can be released from the first mold 12.

According to this embodiment, the insert 16 is attached to the drive portion 44 in a swingable manner. Thus, even if the direction in which the insert 16 advances and retracts and the direction in which the side portion 24 deforms during injection molding are different from each other, the insert 16 can be displaced outward in the second direction when the side portion 24 deforms. Therefore, the generation of burrs on the molded article 300 can be suppressed.

The insert 16 tilts with respect to the drive portion 44 in accordance with the deformation of the side portion 24.

According to such a configuration, the first molding surface 28a can be displaced efficiently in the direction of arrow X2 by tilting the insert 16 relative to the drive portion 44.

The driving section 44 has a rod portion 52 extending in the third direction (driving direction). The insert 16 has a connection hole 42 into which the rod portion 52 is inserted. The first gap S1 and the second gap S2 are provided between the outer peripheral surface of the rod portion 52 and the inner peripheral surface of the connection hole 42 in a manner so that the insert 16 can be tilted in the circumferential direction of the rod portion 52.

According to such a configuration, the connecting structure between the insert 16 and the drive portion 44 can be simplified.

A mold device 10 is provided with the guide member 46 and the support member 48. The guide member 46 is attached to the mounting surface 56 of the first mold 12 and guides the insert 16 in the advancing and retracting direction (driving direction) of the insert 16. The support member 48 supports the insert 16 on the guide member 46 so that the insert 16 pushed by the side portion 24 during injection molding can be tilted.

According to such a configuration, the guide member 46 does not prevent the tilting of the insert 16 and thus the insert 16 can be smoothly advanced and retracted in the third direction.

The recess 35 (the first groove 36 and the second groove 38) is formed on a surface of the insert 16 facing the mounting surface 56. The guide member 46 has the engaging portion 62 inserted into the second groove 38 and the extending portion 64 extending from the engaging portion 62 toward the mounting surface 56. The engaging portion 62 protrudes more in the first direction than the extending portion 64. The support member 48 is attached to the insert 16 so as to be positioned between the engaging portion 62 and the first mold 12. The guide member 46 is fastened to the mounting surface 56 by a fastening member 54.

According to such a configuration, the insert 16 can be easily mounted on the mounting surface 56 of the first mold 12 in a slidable state.

The support member 48 has the fixing member 68 for fixing the support body 66 to the insert 16, and the elastic member 78 interposed between the fixing member 68 and the support body 66.

According to such a configuration, since the elastic member 78 can be elastically deformed when the insert 16 tilts with respect to the drive portion 44, it is possible to prevent an excessive force acting on the guide member 46 from the insert 16.

The mold device may be configured in a manner so that when the side portion of the second mold is deformed by the injection pressure, the insert pushed by the side portion slides outward in the second direction relative to the drive portion (rod portion) and the guide member (the insert is displaced in the second direction without tilting).

The present embodiment discloses the following contents.

The above embodiment discloses a mold device (10) wherein a cavity (18) for injection molding of a molded article (300) is formed by a first mold (12), a second mold (14), and an insert (16), the cavity includes a first cavity portion (18a) that extends in a second direction perpendicular to a first direction that is a mold clamping direction of the first mold and the second mold, a second cavity portion (18b) that extends from the first cavity portion in a direction intersecting the second direction, and a third cavity portion (18c) that is positioned at an extended end portion of the second cavity portion and is configured to mold an undercut portion (302) of the molded article, the first mold molds an inner surface of the molded article, the second mold molds an outer surface of the molded article, the insert molds the undercut portion, and during the injection molding, a side portion (24) of the second mold forming the second cavity portion deforms outward in the second direction by injection pressure, and the insert is displaced along with the deformation of the side portion, the mold device comprising a drive portion (44) that is configured to move the insert in a drive direction intersecting the second direction in a manner so that the insert advances and retracts between a molding position at which the molded article is molded and a retracted position at which the molded article is released, wherein the insert is swingably attached to the drive portion.

In the above-described mold device, the insert may be tilted relative to the drive portion along with the deformation of the side portion.

The above mold device may be configured as follows: the drive portion includes a rod portion (52) extending in the drive direction, the insert includes a connection hole (42) into which the rod portion is inserted, and a gap (S1, S2) is provided between the outer peripheral surface of the rod portion and the inner peripheral surface of the connection hole in a manner so that the insert is tiltable in a circumferential direction of the rod portion.

The mold device may further include a guide member (46) that is mounted on a mounting surface (56) of the first mold and guides the insert in the drive direction and a support member (48) that supports the insert on the guide member in a manner so that the insert pushed to the side portion during the injection molding is tiltable.

The mold device may be configured as follow: a recess (35) is formed on a surface of the insert facing the mounting surface, the guide member includes an engaging portion (62) that is inserted into the recess, and an extending portion (64) that extends from the engaging portion toward the mounting surface, the engaging portion protrudes further in the first direction than the extending portion, the support member includes a support body (66) that is attached to the insert so as to be positioned between the engaging portion and the first mold, and the guide member is fastened to the mounting surface by a fastening member (54).

In the above mold device, the support member may include a fixing member (68) that fixes the support body to the insert, and an elastic member (78) that is interposed between the fixing member and the support body.

It should be noted that the present invention is not limited to the above-described embodiment, and various configurations can be adopted without departing from the gist of the present invention.

What is claimed is:

1. A mold device wherein
a cavity for injection molding of a molded article is formed by a first mold, a second mold, and an insert,
the cavity includes
a first cavity portion that extends in a second direction perpendicular to a first direction that is a mold clamping direction of the first mold and the second mold,
a second cavity portion that extends from the first cavity portion in a direction intersecting the second direction, and
a third cavity portion that is positioned at an extended end portion of the second cavity portion and is configured to mold an undercut portion of the molded article,
the first mold molds an inner surface of the molded article,
the second mold molds an outer surface of the molded article,
the insert molds the undercut portion, and
during the injection molding, a side portion of the second mold forming the second cavity portion deforms outward in the second direction by injection pressure, and the insert is displaced along with the deformation of the side portion,
the mold device comprising
a drive portion that is configured to move the insert in a drive direction intersecting the second direction in a manner so that the insert advances and retracts between a molding position at which the molded article is molded and a retracted position at which the molded article is released,
wherein
the insert is swingably attached to the drive portion.

2. The mold device according to claim 1, wherein
the insert is tilted relative to the drive portion along with the deformation of the side portion.

3. The mold device according to claim 2,
wherein
the drive portion includes a rod portion extending in the drive direction,
the insert includes a connection hole into which the rod portion is inserted, and
a gap is provided between an outer peripheral surface of the rod portion and an inner peripheral surface of the connection hole in a manner so that the insert is tiltable in a circumferential direction of the rod portion.

4. The mold device according to claim 1, further comprising:
a guide member that is mounted on a mounting surface of the first mold and guides the insert in the drive direction; and
a support member that supports the insert on the guide member in a manner so that the insert pushed to the side portion during the injection molding is tiltable.

5. The mold device according to claim 4,
wherein
a recess is formed on a surface of the insert facing the mounting surface,
the guide member includes
an engaging portion that is inserted into the recess, and
an extending portion that extends from the engaging portion toward the mounting surface,
the engaging portion protrudes further in the first direction than the extending portion,
the support member includes a support body that is attached to the insert so as to be positioned between the engaging portion and the first mold, and
the guide member is fastened to the mounting surface by a fastening member.

6. The mold device according to claim 5,
wherein
the support member includes
a fixing member that fixes the support body to the insert, and
an elastic member that is interposed between the fixing member and the support body.
